(19) United States
(12) Patent Application Publication
(10) Pub. No.: US 2018/0043895 A1
(43) Pub. Date: Feb. 15, 2018

(54) VEHICLE SOFT-PARK CONTROL SYSTEM

(71) Applicant: GM Global Technology Operations LLC, Detroit, MI (US)

(72) Inventors: Constandi J. Shami, Ann Arbor, MI (US); Arthur D. Drennen, Commerce Township, MI (US)

(21) Appl. No.: 15/235,259

(22) Filed: Aug. 12, 2016

(51) Int. Cl. B60W 30/18; B60T 8/1755; B60W 10/18; F16H 63/48; B60W 10/184; B60T 7/12; B60T 8/24

(52) U.S. Cl. CPC B60W 30/18109; B60T 7/12; B60T 8/17555; B60T 8/245; F16H 63/486; B60W 10/184; B60W 10/182; B60T 2201/10; B60T 2260/04; F16H 63/3425

(57) ABSTRACT

A soft-park control system to control vehicle movement during parking of a vehicle includes a transmission and one or more brake assemblies. The transmission includes a parking pawl that mechanically engages a notch in a parking gear. The brake assembly includes an electro-mechanical actuator configured to apply a variable brake force to a wheel coupled to a brake assembly based on an existing brake pressure. The soft-park control system further includes an electronic control unit having a soft-park hardware controller in electrical communication with the electro-mechanical actuator. The electronic brake control unit outputs a brake pressure signal that adjusts the existing brake pressure so as to control a rate at which the parking pawl engages the notch.

### FIELD OF THE INVENTION

The present disclosure relates generally to automotive vehicles, and more particularly, to vehicle transmission systems.

### BACKGROUND

Automotive vehicles implement a transmission system to provide one or more driving states. The transmission system includes a gearbox that employs various gears and gear trains to provide speed and torque conversions from a rotating power source to the vehicle wheels. In automatic-type transmission systems, the gear-box typically includes a parking pawl that selectively engages a notched gear to lock the gear train and park the vehicle. The parking pawl engages one of the notches in the gear when a driver manipulates the shifting lever from a driving position (e.g., drive or reverse) into a park position.

When transitioning from a driven gear (e.g., drive or reverse) to park, it is necessary for a driver to utilize the vehicle braking system and overcome driveline resting torque such that the parking pawl may be properly engaged. At times, it may be necessary to place the vehicle in park while the vehicle is located on an incline/decline. In this scenario, the pawl is engaged into place as the driver releases his/her foot from the brake pedal. The engagement of pawl coupled with the vehicle's momentum can cause the vehicle to abruptly stop or lurch. The vehicle's momentum, especially when located on an incline or decline, also causes significant longitudinal oscillations, i.e., causes the vehicle to oscillate back and forth from the front wheels to the back wheels.

### SUMMARY OF THE INVENTION

According to at least one non-limiting embodiment, a soft-park control system to control parking of a vehicle includes a transmission and one or more brake assemblies. The transmission includes a parking pawl that mechanically engages a notch in a parking gear. The brake assembly includes an electro-mechanical actuator configured to apply a variable brake force to a wheel coupled to a brake assembly based on an existing brake pressure. The soft-park control system further includes an electronic control unit having a soft-park hardware controller in electrical communication with the electro-mechanical actuator. The electronic brake control unit outputs a brake pressure signal that adjusts the existing brake pressure so as to control a rate at which the parking pawl engages the notch.

According to another non-limiting embodiment, a soft-park control system configured to control parking of a vehicle comprises at least one brake assembly including an electro-mechanical actuator configured to apply a variable brake force to a wheel coupled to the at least one brake assembly based on an existing brake pressure. An electronic parking brake is configured to apply a constant brake force that locks in place a rotational position of a rotor included in the at least one brake assembly. The soft-park control system further includes an electronic control unit including a soft-park hardware controller that is in electrical communication with the electro-mechanical actuator. The electronic brake control unit is configured to output a brake pressure signal that adjusts the existing brake pressure while engaging the electronic parking brake.

According to yet another non-limiting embodiment, a method of parking a vehicle comprises detecting a request to transition the vehicle from a drive gear to a park gear, and mechanically transitioning a parking pawl from a disengaged state to an engaged state in response to the request. In response to transition the parking pawl, the method further comprises adjusting an existing brake pressure of the brake assembly so as to control a rate at which the parking pawl engages a notch on the park gear to park the vehicle.

The above features are readily apparent from the following detailed description of the invention when taken in connection with the accompanying drawings.

### BRIEF DESCRIPTION OF THE DRAWINGS

Other features and details appear, by way of example only, in the following detailed description of embodiments, the detailed description referring to the drawings in which:

FIG. 1 is a block diagram of a vehicle including a vehicle soft-park control system according to a non-limiting embodiment;

FIGS. 2A-2B illustrate a transmission including a parking pawl configured to engage a notched gear;

FIG. 3 illustrates a brake assembly including an electro-mechanical actuator controlled by a hardware controller to soft-park the vehicle according to a non-limiting embodiment;

FIG. 4 is a block diagram of an electronic brake system (EBS) controller configured to control a brake assembly and soft-park a vehicle according to a non-limiting embodiment;

FIG. 5A is a signal-timing diagram illustrating performance results of various systems and components of according to a conventional braking system;

FIG. 5B is a signal-timing diagram illustrating expected performance results of various systems and components of a vehicle undergoing a soft-park operation according to a non-limiting embodiment;

FIG. 6 is a flow diagram illustrating a method of soft-parking a vehicle according to a non-limiting embodiment; and

FIG. 7 is a flow diagram illustrating a method of soft-parking a vehicle according to another non-limiting embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

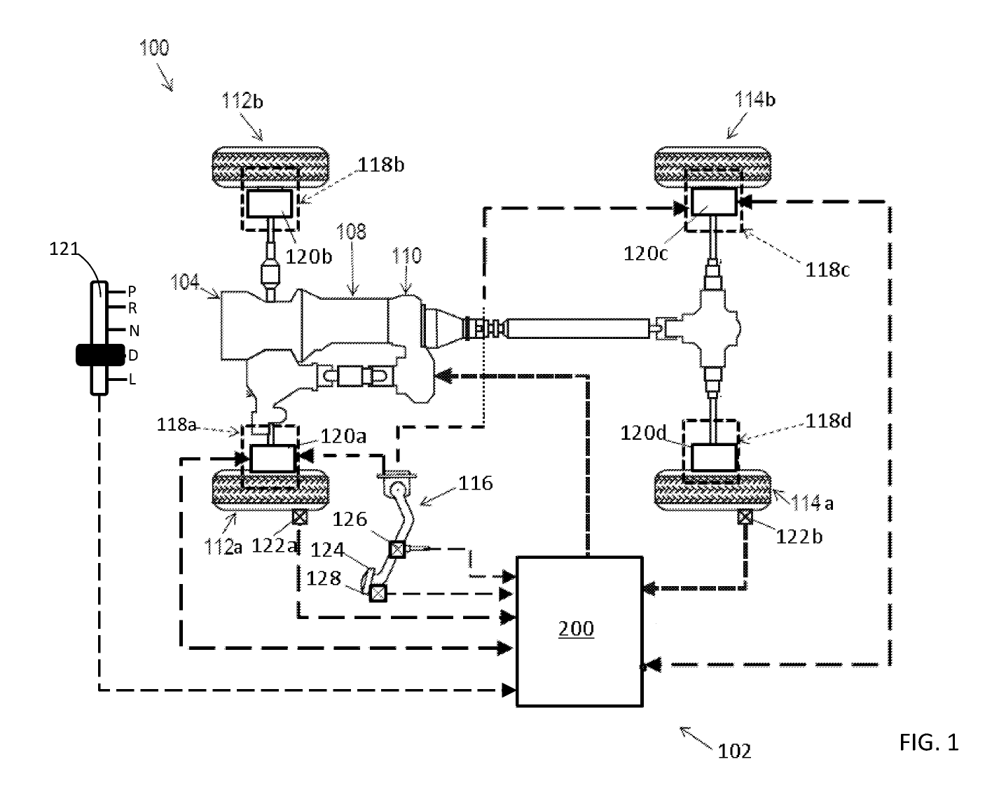

With reference now to FIG. 1, a vehicle 100, including a soft-park control system 102 is illustrated according to a non-limiting embodiment. The vehicle 100 is driven via a powertrain system that includes an engine 104, a transmission 108 and a transfer case 110. The engine 104 includes, for example, an internal combustion engine 104 that is configured to generate drive torque that drives front wheels 112a-112b and rear wheels 114a-114b using various components of the vehicle driveline. Various types of internal combustion engines 104 may be employed in the vehicle 100 including, but not limited to a diesel engine and a gasoline engine, as well as an electric motor, and a hybrid-type engine that combines an internal combustion engine with an electric motor, for example. The vehicle driveline may be understood to comprise the various powertrain components, excluding the engine 104.

The drive torque generated by the engine 104 is transferred to the transmission 108 via a rotatable crank shaft (not shown). In at least one embodiment, the torque supplied to the transmission 108 may be adjusted in various manners including, for example, by controlling operation of the engine 104, or via operation of the transfer case as understood by one of ordinary skill in the art.

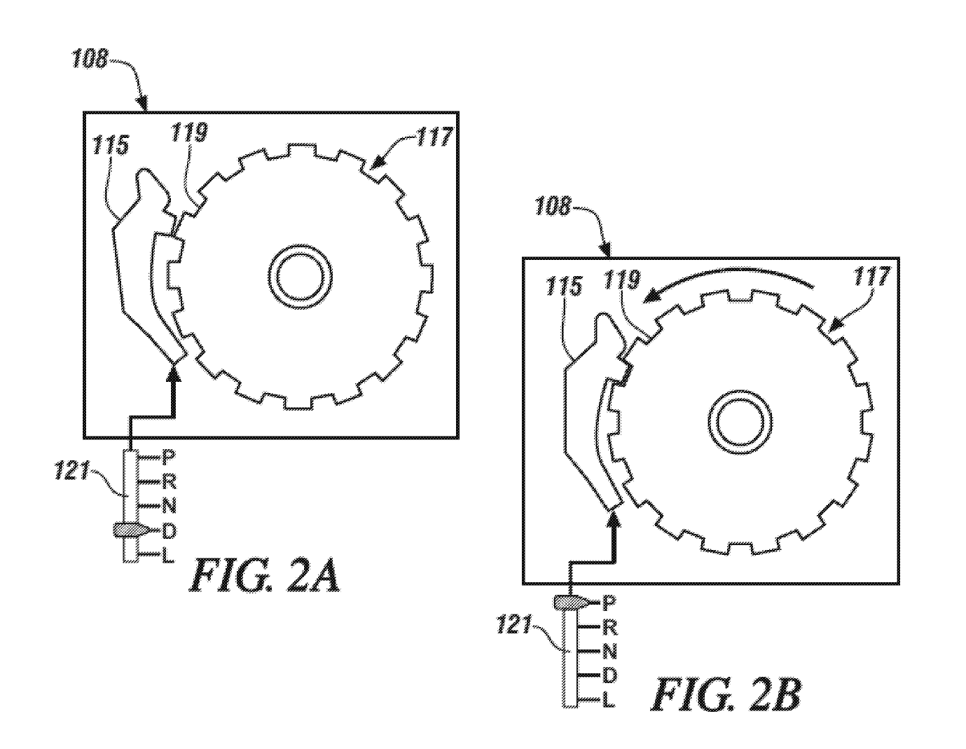

The transmission 108 employs various gears and gear trains to provide speed and torque conversions via drive shafts to the vehicle wheels 112a/112b-114a/114b. In automatic-type transmission systems, the transmission 108 typically includes a parking pawl 115 that selectively engages a notched gear 117 to lock the gear train and park the vehicle 100 (see FIGS. 2A and 2B). The parking pawl 115 mechanically engages (e.g., pivotably engages) one of the notches 119 in the gear 115 when a driver manipulates the shifting lever 121 from a driving position (e.g., R, N, D, L) into a park position (P). The engagement of the park pawl is detected and a soft-park activation counter is incremented. The EBS controller 200 may detect that the parking pawl is engaged. For example, the EBS controller determines the parking paw is engaged in response to detecting that the gear train of the transmission 108 is locked, i.e., is prevented from rotating.

At times, the parking pawl 115 may contact an outer surface of the gear 117 before engaging the next notch 119. Accordingly, the gear 117 rotates slightly such that the parking pawl 115 can engage the notch. The rotation of the gear 117 also causes the vehicle 100 to move. The rate (e.g., speed) at which the parking pawl 115 slides along the gear 117 before engaging the notch 119 is referred to as the pawl engagement rate, which may be precisely controlled by the soft-park control system as discussed in greater detail herein.

The soft-park control system 102 comprises a hardware controller 200 such as, for example, an electronic brake system (EBS) controller 200 in signal communication with the transmission 108 (e.g., the gearbox), a pedal assembly 116, one or more brake assemblies 118a-118d (i.e., brake corner modules) installed with respective actuator units 120a-120d, one or more wheel sensors 122a-122b, and shift lever 121. The soft-park control system 102 may be implemented in a traditional mechanical braking system, a brake-by-wire (BBW) system, or a hybrid BBW system which includes a fault tolerant mechanical braking system.

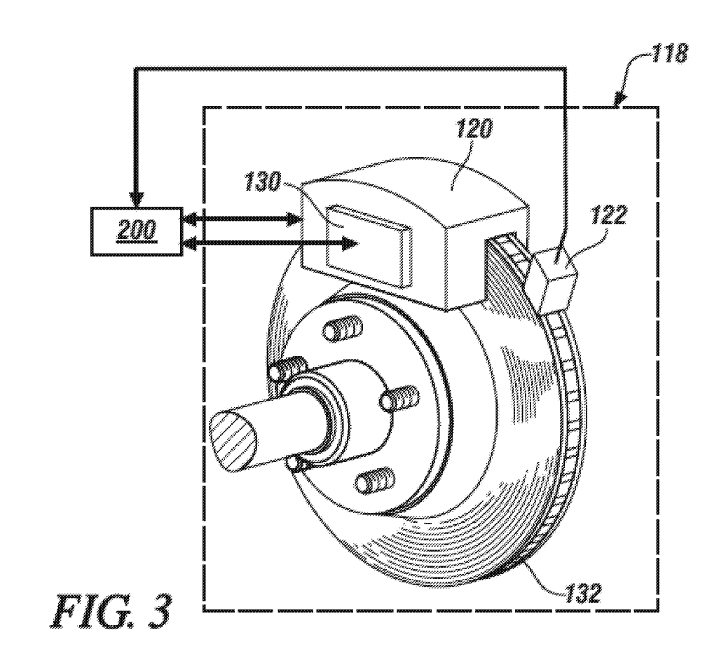

Referring to FIG. 3, a brake assembly 118 included in a mechanical braking system is illustrated according to a non-limiting embodiment. The brake assembly 118 may include a traditional, hydraulic brake system, a wired brake system, i.e., a brake-by-wire (BBW) system, or a hybrid electro-mechanical brake system. In at least one embodiment, the brake assembly 118 includes an actuator 120 such as, for example, a fluid-pressure-controlled brake caliper 120. The brake caliper 120 may include an electro-mechanical valve (e.g., a digital/analog-controlled valve not shown) that controls pressure in the brake line (not shown) based on the valve's positioning from an open state to a closed state (and any position therebetween). For example, a fully close state may maintain full brake pressure in the brake line such that the brake calipers 120 apply full braking force (i.e., braking torque) to the wheels. A fully open state of the valve allows the fluid in the brake line to bleed out, thereby releasing the brake calipers 120 and allowing the wheels to rotate.

The brake calipers 120 (e.g., the electro-mechanical valve) are in signal communication with the EBS controller 200. In this manner, the EBS controller 200 may output a brake pressure control signal capable of varying the position of the brake caliper 120 (e.g., the electro-mechanical valve) so as to precisely control and adjust the fluid pressure in the brake line. For instance, the EBS controller 200 may adjust the position of the valve from the closed position to the open position (and any position therebetween). In addition, the EBS controller 200 may control the speed at which the valve transitions from the closed position to the open position (and vice versa). In either case, the controller 200 is therefore capable of adjusting or precisely controlling the rate at which the brake pressure (e.g., pressure in the brake line) is reduced. Accordingly, the rate at which the calipers release the wheels to allow wheel rotation may be precisely controlled.

The brake assembly may further include an electronic parking brake (EPB) 130. The EPB 130 may be integrated with an actuator (e.g., motor) that drives a piston, which in turn forces the brake caliper 120 to apply a clamping force to the wheel rotor 132. Accordingly, the wheel coupled to the respective rotor 132 may be locked into place independently from the engagement of the parking pawl 115.

A brake assembly 118 installed in a brake-by-wire (BBW) system operates in a similar manner as described above. Instead of the fluid-pressure bleed line, however, the brake caliper 120 is constructed as an electronic caliper (e-caliper) which is controlled by an integrated motor (not shown). The motor is controlled according to the brake pressure control signal output from the EBS controller 200. For instance, the EBS controller 200 may adjust the current delivered to the motor so as to control the direction and/or speed at which the motor operates. In turn, the motor drives the e-caliper so as to adjust the braking force (i.e., braking torque) applied to the wheels. Accordingly, the rate at which the calipers release or engage the wheels may be precisely controlled.

Referring again to FIG. 1, the pedal assembly 116 is in signal communication with the EBS controller 200, and includes a brake pedal 124, a pedal pressure sensor 126, and a pedal travel sensor 128. The EBS controller 200 is configured to detect a braking distance and/or braking force applied to the brake pedal 124 based on respective signals output from the pedal pressure sensor 126, and a pedal travel sensor 128.

The EBS controller 200 may include additional sub-controllers including, but not limited to, a brake assist controller (not shown), a pressure boost controller (not shown), and an EPB controller (not shown). The brake assist controller determines parameters associated with deceleration actions by the operator and determines if assistance should be provided to aid the operator and how much assistance is to be applied. The brake assist controller may send a signal to the engine controller to request that the engine reduce the power output. This action will aid in decelerating the vehicle. It should be appreciated that in other embodiments, the controllers may be embodied in separate components and arranged in a distributed manner rather than an integrated control scheme as illustrated.

The brake assist controller may further transmit a signal to the pressure boost controller to change the amount of pressure a brake booster is applying to the brake hydraulic system. The pressure boost controller in turn changes the hydraulic pressure applied to the wheel brakes. The brake assist controller further monitors the operation of the vehicle 100 such as via the brake apply sensors (e.g. brake pedal travel and brake pedal force) and the wheel speed sensors.

In the event that the brake assist controller determines, such as via sensors that indicate the braking system is not operating at a desired performance level, a signal may be transmitted to the EPB controller. The signal may include a desired rotor clamp load for example. It should be appreciated that brake assist controller may also transmit a signal to the boost controller to hydraulically isolate the rear brakes from the front brakes.

The EPB controller transmits an EPB activation signal to the EPB 130 causing the brake calipers to clamp the rotors 132 with the desired amount of clamping force. In one embodiment, the clamping force is proportional to the deceleration request from the operator. The EPB activation signal may be transmitted automatically in response to transitioning the vehicle from a drive gear (e.g., R, N, D, L) to park (P), or may be transmitted in response to receiving an input from the driver.

According to a non-limiting embodiment, the pedal pressure sensor 126 is implemented as a pressure transducer or other suitable pressure sensor configured or adapted to precisely detect, measure, or otherwise determine an apply pressure or force imparted to the brake pedal 124 by an operator of vehicle 100. The pedal travel sensor 128 may be implemented as a pedal position and range sensor configured or adapted to precisely detect, measure, or otherwise determine the relative position and direction of travel of brake pedal 124 along a fixed range of motion when the brake pedal 124 is depressed or actuated.

The measurements or readings obtained by the pedal pressure sensor 126 and the pedal travel sensor 128 are transmittable or communicable to one or more EBS controllers 200 or are otherwise determinable thereby as needed for use with one or more braking algorithms stored in memory of the EBS controller 200. The EBS controller 200 is also configured to calculate, select, and/or otherwise determine a corresponding braking request or braking event in response to the detected and recorded measurements or readings output from the wheel sensors 122a-122b. Based on the determined braking request or braking event, the EBS controller 200 outputs a low voltage data command signal that invokes a braking action to slow down the vehicle 100 as discussed in greater detail herein.

The wheel sensors 122a-122b may provide various types of vehicle data including, but not limited to, speed, acceleration, deceleration, vehicle angle (e.g., whether the vehicle is on an incline/decline), and wheel slippage. In at least one embodiment, the vehicle EBS system 102 may include one or more object detection sensors (now shown) disposed at various locations of the vehicle 100. The object detection sensors are configured to detect the motion and/or existence of various objects surrounding the vehicle including, but not limited to, surrounding vehicles, pedestrians, street signs, and road hazards. The EBS controller 200 may determine a scenario (e.g., a request and/or need) to slow down and/or stop the vehicle based on the data provided by the pedal unit 116, the wheel sensors 122a-122d. In response to determining the braking scenario, the EBS controller 200 communicates a braking command signal to one or more brake assemblies 118a-118d to slow or stop the vehicle 100.

In at least one embodiment, the EBS controller 200 outputs a low voltage data signal (e.g., a digital braking command signal) to a driver component or power circuit via a datalink. In at least one embodiment, one or more braking command signals are transmitted across one or more command signal transmission channels or lines to initiate operation of a driver that drives an actuator of the brake assembly 118a-118d. The signal transmission channels may include a message-based communication bus such as, for example, a controller area network (CAN) bus.

In at least one embodiment, the EBS controller 200 includes programmable memory and a microprocessor. In this manner, the EBS controller 200 is capable of rapidly executing the necessary control logic for implementing and controlling the actuators 120a-120d using a brake pedal transition logic method or algorithm which is programmed or stored in memory.

The EBS controller 200 (e.g., the memory) may be preloaded or preprogrammed with one or more braking torque look-up tables (LUTs), i.e. braking torque data tables readily accessible by the microprocessor in implementing or executing a braking algorithm. In at least one embodiment, the braking torque LUT stores recorded measurements or readings of the pedal pressure sensor 126 and contains an associated commanded braking request appropriate for each of the detected force measurements as determined by the pedal pressure sensor 126. In a similar manner, the EBS controller 200 may store a pedal position LUT, which corresponds to the measurements or readings of the pedal travel sensor 128 and contains a commanded braking request appropriate for the detected position of pedal travel sensor 128.

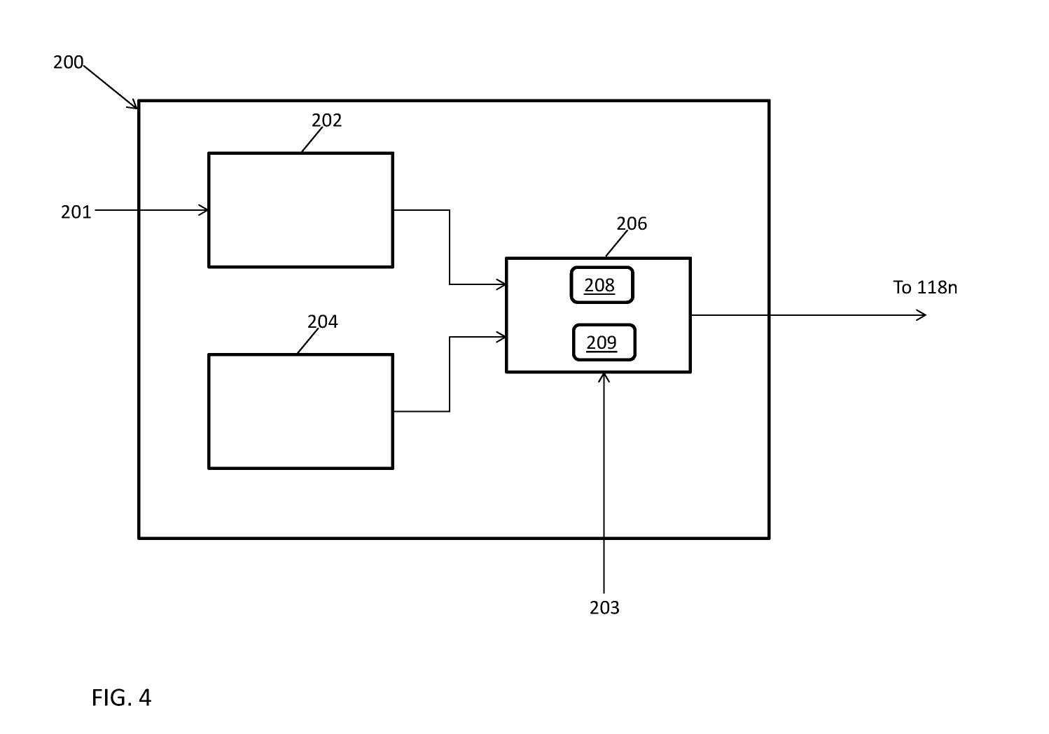

Turning now to FIG. 4, an EBS controller 200 in signal communication with a brake assembly (e.g., 118a) to soft-park a vehicle is illustrated according to a non-limiting embodiment. The EBS controller 200 includes a memory unit 202, an inertial measurement unit (IMU) 204, and an electronic soft-park hardware controller 206. Although the EBS controller 200 illustrates only three sub-modules/controllers for clarification purposes, it should be appreciated that the EBS controller 200 may include additional sub-modules/controllers such as, for example, a brake assist controller, a pressure boost controller, and an EPB controller as described in detail above.

The memory unit 202 may store various logic formulas and/or algorithms capable of controlling the operation of various components installed in the brake assembly including, but not limited to, the caliper, actuators, and/or the EPB 130. The memory unit 202 may also be preloaded or preprogrammed with one or more braking torque look-up tables (LUTs) i.e. braking torque data tables readily accessible by the microprocessor in implementing or executing a braking algorithm. In at least one embodiment, the braking torque LUT stores recorded measurements or readings 201 from various sensors such as, for example, the pedal pressure sensor, and contains an associated commanded braking request appropriate for each of the detected force measurements as determined by the pedal pressure sensor. In a similar manner, the memory unit 202 may store a pedal position LUT, which corresponds to the measurements or readings of the pedal travel sensor and contains a commanded braking request appropriate for the detected position of pedal travel sensor.

In at least one embodiment, the IMU 204 is constructed as an electronic device that measures and reports a body's specific force, angular rate, and sometimes the magnetic field surrounding the body, using a combination of accelerometers and gyroscopes, as well as magnetometers. The IMU 204 may also output one or more inertial signals indicating various characteristics or parameters of the vehicle including, but not limited to, lateral acceleration, longitudinal acceleration, yaw rate, vehicle angle (e.g., an incline/decline of the vehicle), gravity force, and GPS data.

The soft-park controller 206 is configured to control brake pressure in the brake lines of each brake assembly based on the surface grade (e.g., incline or decline) of the vehicle and other vehicle data 203 provided by sensors located on the vehicle. According to a non-limiting embodiment, the soft-park controller 206 may continuously calculate the surface grade. When the driver transitions the vehicle from a drive state into park, the soft-park controller 206 determines a decay rate at which to reduce the existing brake pressure (i.e., the pressure that currently exists in the brake line at a given point in time) based on the calculated surface grade. The decay rate is the rate at which the soft-park controller 206 commands the caliper to gradually ramp down (i.e., gradually reduce) the existing brake pressure to a predetermined value such as, for example, approximately 0 pounds per square inch (psi), sometimes referred to as 0 bar.

The surface grade of the vehicle may be constantly calculated and the most recent surface grade may be stored in memory 202 for future reference. In at least one embodiment, a level of grade may be assigned a zero value (0) indicative of a level surface, and the surface grade may be a calculated as a negative or positive percent deviation from 0. In at least one embodiment, a percentage range is assigned a grade category. For example, (+/−) 1% to 10% may indicate a low incline/decline, 11%-20% may indicate a medium incline/decline, and 21% or higher may indicate a high or steep incline/decline. These grade ranges may be stored in the memory unit 202 and constantly referenced to determine the grade category of the vehicle exists in real-time.

In at least one non-limiting embodiment, the current existing surface grade (GRADE) may be determined, for example, according to the expression:

GRADE=ROL_RES+AERO_DRAG+ENG_BR+BRAKE_TQ+ACCEL (6)

where ROLL_RES is the rolling resistance, AERO_DRAG is the aerodynamic drag, ENG_BR is the engine braking torque, BRAKE_TQ is the brake torque, and ACCEL is the vehicle acceleration. It should be appreciated that the equation above is provided as only one example, and various other methods or equations for determining a current existing surface grade may be implemented.

In at least one embodiment, the soft-park controller stores grade LUT 208 that includes a plurality of grade values indicative of a respective surface grade. Each grade value correlates with a respective pre-stored decay rate. In this manner, the soft-park controller 206 may determine the decay rate by comparing the calculated current surface grade of the vehicle to a pre-stored grade value in the LUT 208, and then selects the decay rate that corresponds with the matching grade value.

In addition, the soft-park controller 206 is capable of determining the minimum brake pressure necessary to hold (i.e., maintain) braking of the vehicle at the current existing surface grade. In a similar manner described above, the soft-park controller 206 may include a pressure LUT 209 stored with a plurality of pre-stored grade values indicative of a respective surface grade. Each grade value correlates with a corresponding minimum brake pressure value indicative of the minimum brake pressure that holds (i.e., maintains braking) the vehicle at the corresponding surface grade. In this manner, the soft-park controller 206 may determine the minimum brake pressure in response to matching the calculated surface grade of the vehicle with a corresponding grade value stored in the pressure LUT 209.

In at least one embodiment, the soft-park controller 206 may perform an excess brake line pressure dump (i.e., pressure release) based on the minimum brake pressure. For instance, drivers typically manipulate the brake pedal such that more brake pressure than necessary is applied to the brake lines. This excessive brake pressure may cause additional stress on the components of the brake assembly including, but not limited to, the brake line, actuators, valves, etc. To relieve the brake lines of excessive brake pressure, the soft-park controller 206 compares the existing brake pressure to the determined minimum brake pressure, and dumps (i.e., releases) the existing brake pressure in the brake lines until the existing brake pressure matches or substantially matches the determined minimum brake pressure level. In this manner, the vehicle may still be held (maintained) according to the minimum braking pressure while relieving various components of the brake assembly from excessive brake pressure.

When the vehicle is located on a surface grade (i.e., incline or decline), the soft-park controller 206 may release the excess brake pressure prior to ramping down the pressure in the brake lines. After the existing brake pressure reaches the minimum braking pressure, the soft-park controller 206 reduces the existing brake pressure (now existing at the minimum brake pressure level) to, for example, approximately 0 pounds per square inch (psi) at the decay rate. In at least one embodiment, the pressure decay rate is determined according to the calculated surface grade.

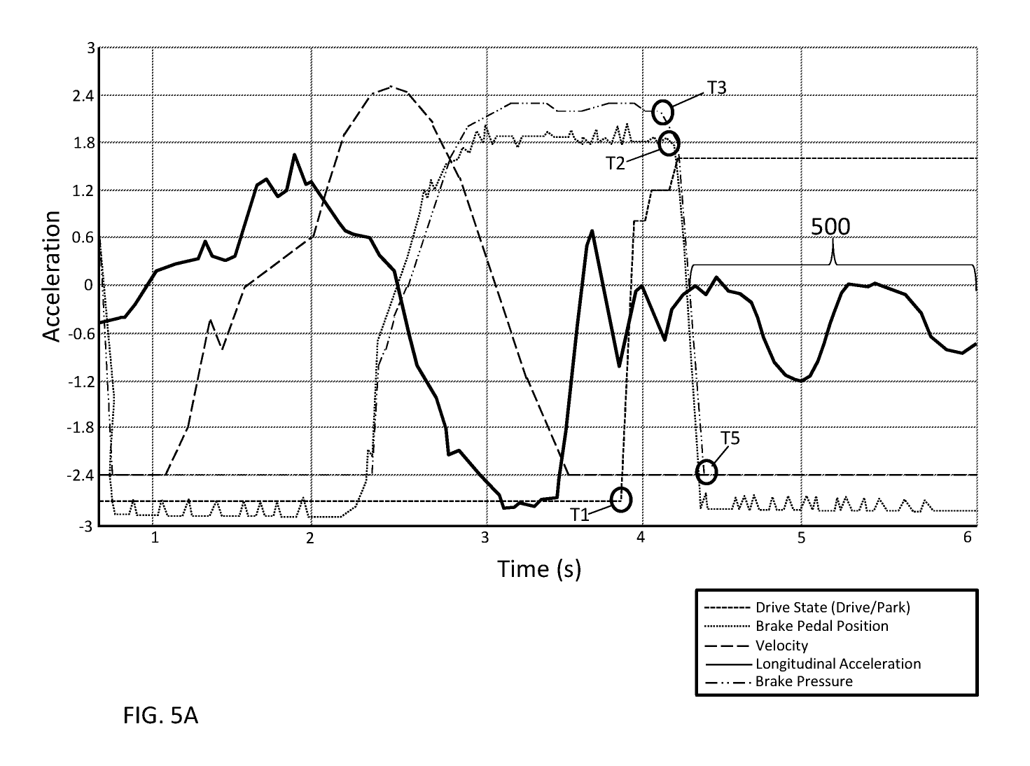

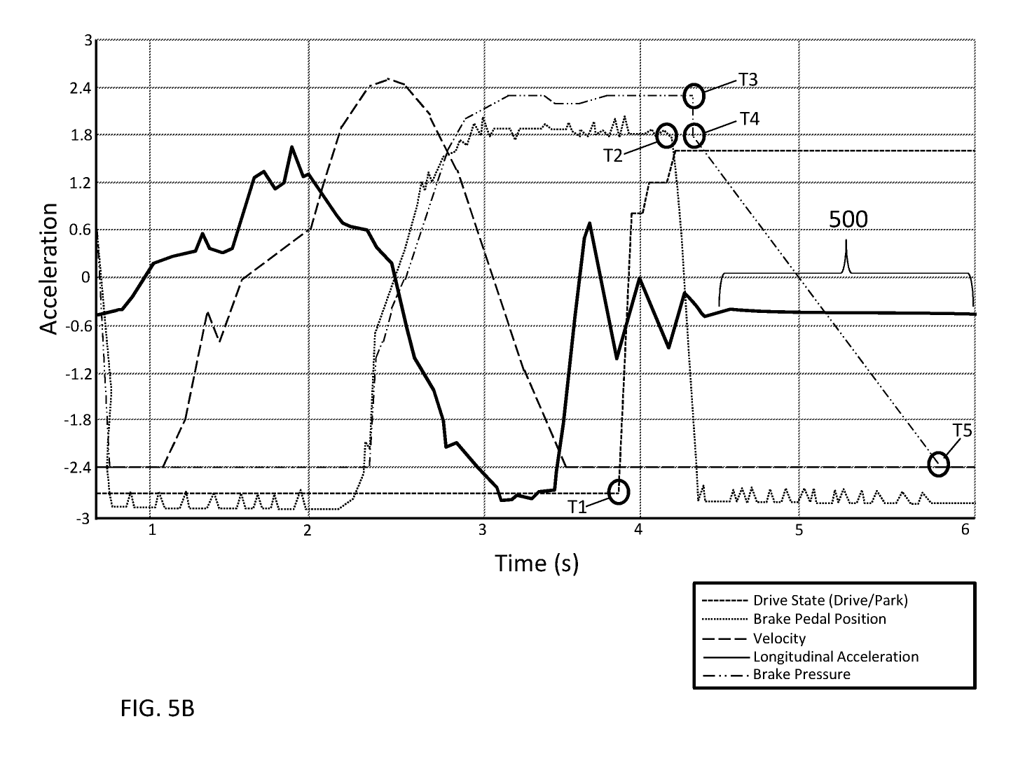

Referring to FIG. 5A, performance results of various systems and components typically realized by a vehicle including a conventional braking system are illustrated. The vehicle experiences significant longitudinal oscillations 500 (i.e., as the vehicle oscillates back and forth from the front wheels to the back wheels) after transitioning the vehicle into park (P) at time T1, and releasing the brake pedal at time T2. This vehicle behavior is typical when parking a vehicle including a conventional brake system on an inclined surface such as, for example, a hill.

Operation of the soft-park controller, however, soft-parks the vehicle, thereby significantly reducing or even eliminating the longitudinal oscillations 500 described above. Referring to FIG. 5B, for example, the soft-park controller 206 detects that the vehicle has been transitioned from drive (D) into park (P) at time T1. At time T2, the soft-park controller 206 detects that the brake pedal has been placed in a steady state (e.g., the driver has removed his/her foot from the brake pedal) and thus the soft-park operation is initiated. However, prior to allowing the vehicle to softly transition into the parking gear (i.e., engage the parking pawl into the gear notch), the soft-park controller 206 releases the excessive brake pressure at time T3. That is, the existing brake pressure is dropped to approximately the minimum brake pressure prior to gradually reducing the existing brake pressure at the decay rate. As shown the brake line pressure drops until the existing pressure reaches the minimum brake pressure. Once minimum brake pressure is reached at time T4, the soft-park controller 206 outputs a control signal that controls the electro-mechanical valve of the brake caliper such that the brake line pressure is gradually ramped down until reaching 0 psi or approximately 0 psi at time T5. By performing the initial excessive pressure release and reducing the brake pressure to the minimum brake pressure, a more constant decay rate (i.e., rate at which pressure in the brake line is reduced to 0 psi) is achieved, which in turns provides a more constant pawl engagement rate. Accordingly, longitudinal oscillations 500 are essentially eliminated as further illustrated in FIG. 5B.

In addition, the soft-park controller 206 may also perform the excessive pressure release in conjunction with applying the EPB. For instance, a lag time typically exists while the actuator (e.g., park brake motor) engages the EPB to apply the clamping force to the rotor. During that lag time, the current existing brake pressure (i.e., the brake pressure existing in the brake line prior to initiating the EPB motor) is held such that the driver does not realize vehicle motion while the EPB is engaged. While the motor drives the EPB, the soft-park controller 206 may perform the excessive pressure release. Once the minimum brake pressure is reached, the minimum brake pressure in the brake lines is held until EPB engagement is completed. When the soft-park controller 206 confirms that the EPB is engaged, the remaining minimum brake pressure in the brake lines is ramped down to 0 psi or approximately 0 psi. In this manner, the driver does not realize vehicle motion while the EPB is engaged.

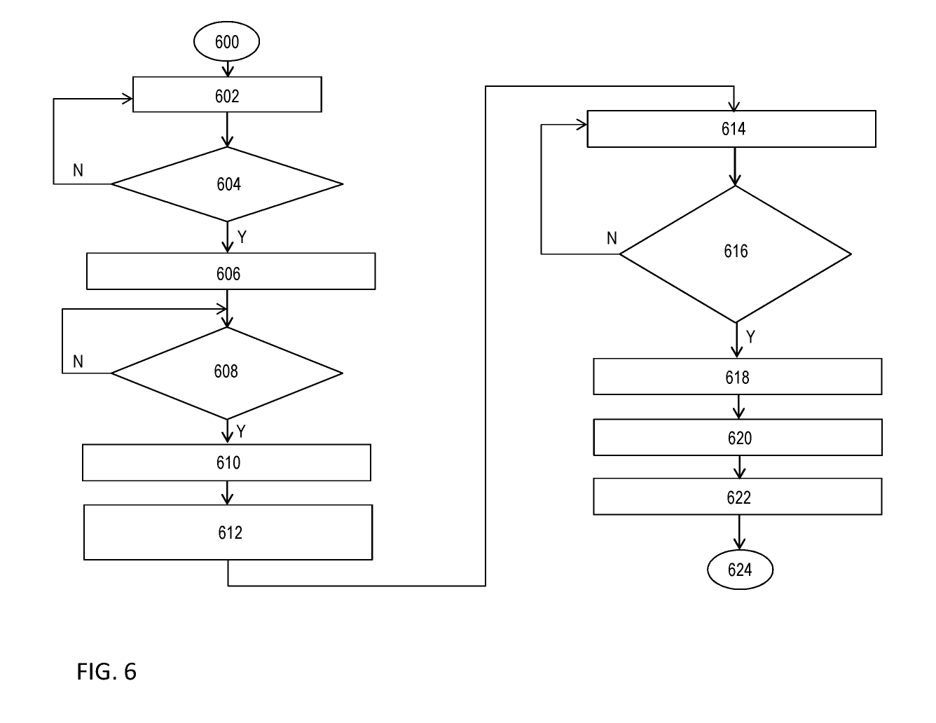

Turning to FIG. 6, a flow diagram illustrates a method of soft-parking a vehicle according to a non-limiting embodiment. The method begins at operation 600, and at operation 602 the grade (e.g., incline or decline) at which the vehicle exists is calculated. In at least one embodiment, a level of grade may be assigned a zero value (0) and the grade may be a calculated as a negative or positive percent deviation from 0. In at least one embodiment, a percentage range is assigned a grade category. For example, +/−1 percent (%) to 10% may indicate a low incline/decline, 11%-20% may indicate a medium incline/decline, and 21% or higher may indicate a high or steep incline/decline. These grade ranges may be stored in memory of the EBS controller 200 and constantly referenced to determine the grade category of the vehicle in real-time. At operation 604, a determination is made as to whether the vehicle has been transitioned into a park gear state, e.g., from a driving gear (D) into park (P). When the vehicle has not transitioned from a gear state (e.g., R, N, D, L) into park (P), the method returns to operation 602 and continues calculating the grade. In at least one embodiment, the operations described in steps 602-604 may be performed simultaneously.

When, however, the vehicle transitions from a gear state (e.g., R, N, D, L) into park (P), the soft-park operation is invoked at operation 606, and the method determines whether the driver of the vehicle has removed their foot from the brake pedal or has manipulated the brake pedal to a position acceptable to engage the parking pawl at operation 608. The determination of whether driver's foot has been removed or is in the process of being removed from the brake pedal may be based on the output of the brake pedal speed sensor and/or the brake pedal position sensor, for example. When brake force has not been removed from the pedal (e.g., the driver's foot has not been lifted from the pedal), the method returns to operation 608, and continues monitoring the pedal.

When, however, brake force has been removed from the pedal (e.g., the driver's foot has been removed from the pedal) or is in the process of being removed, the current existing pressure (e.g., actual pressure) in the brake lines is determined at operation 610. At operation 612, a minimum brake pressure is determined. The minimum brake pressure is the minimum brake pressure necessary to hold the vehicle at the calculated grade. At operation 614, the excessive brake pressure (i.e., the difference between the existing brake pressure and the minimum hold pressure) is released from the brake line.

At operation 616, a determination is made as to whether the existing brake pressure after releasing the excessive brake pressure has reached the minimum hold pressure. When the existing brake pressure has not reached the minimum hold pressure, the method returns to operation 614 and continues releasing the excessive brake pressure. When, however, the existing brake pressure reaches the minimum hold pressure, the method proceeds to operation 618 and gradual pressure-ramp out (i.e., pressure decay) to 0 bar is performed based on calibration. The gradual pressure-ramp out in turns controls the pawl engagement rate allowing the parking pawl to softly engage the gear notch despite the vehicle being located on an inclined or declined surface. At operation 620, the engagement of the park pawl is detected and a soft-park activation counter is incremented. The engagement may be detected in response to detecting that the gear train of the transmission is locked, i.e., is prevented from rotating. The soft-park activation counter may be utilized to prevent excessive initiation of the soft-park operation. For instance, a driver may decide to no longer park the vehicle before the parking pawl is engaged, and instead may reapply the brake pedal causing the soft-park system to re-invoke the soft-park operation. If the soft-park activation counter reaches a threshold value during a pre-determined time period (e.g., 10 seconds), the soft-park system may prevent further usage of the soft-park operation until a reset period has been reached (e.g., 1 minute). When the counter has not reached the threshold value, the parking pawl softly engages a corresponding gear notch at operation 622, and the method ends at operation 624. In this manner, the vehicle can be softly-parked on a grade without the momentum causing the vehicle to oscillate before coming to a stop.

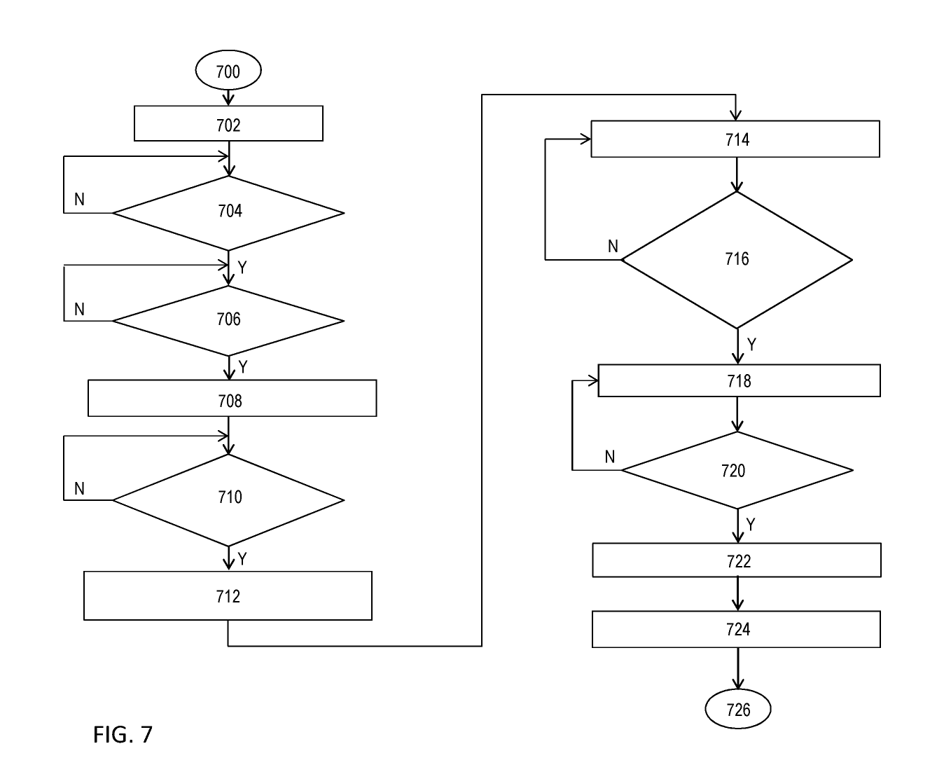

Turning to FIG. 7, a flow diagram illustrates a method of soft-parking a vehicle according to another non-limiting embodiment. In this case, the vehicle includes an electronic parking brake (EPB) that is engaged along with invoking the soft-park operation described in detail above. The method begins at operation 700, and at operation 702 the grade (e.g., incline or decline) of the vehicle is calculated. In an embodiment, a level of grade may be assigned a zero value (0) and the grade may be a calculated as a negative or positive percent deviation from 0. In at least one embodiment, a percentage range is assigned a grade category. For example, +/−1 percent (%) to 10% may indicate a low incline/decline, 11%-20% may indicate a medium incline/decline, and 21% or higher may indicate a high or steep incline/decline. These grade ranges may be stored in memory of the EBS controller 200 and referenced to determine the grade category of the vehicle in real-time. At operation 704, a determination is made as to whether the vehicle has been transitioned into a park gear state, e.g., from a drive (D) into park (P). When the vehicle has not transitioned from a driving gear state (e.g., R, N, D, L) into park (P), the method returns to operation 702 and continues calculating the grade.

When, however, the vehicle transitions from a driving gear state (e.g., R, N, D, L) into park (P), the method proceeds to operation 706 and determines if the vehicle has stopped (e.g., reached 0 miles per hour). In at least one embodiment, the operations described in steps 702-706 may be performed simultaneously. When the vehicle has not yet stopped, the method returns to operation 706 and continues to monitor the speed of the vehicle. When, however, the vehicle has stopped (e.g., reached 0 MPH), the soft-park operation is invoked at operation 708, and the method determines whether the driver of the vehicle has removed his/her foot from the brake pedal or has essentially started to remove his/her foot from the brake pedal at operation 710. The determination of whether driver's foot has been removed or is in the process of being removed from the brake pedal may be based on the output of the brake pedal speed sensor and/or the brake pedal position sensor, for example. When brake force has not been removed from the pedal (e.g., the driver's foot has not been lifted from the pedal), the method returns to operation 710, and continues monitoring the pedal. When it is determined that the driver has removed his/her foot from the brake pedal or is in the process of removing his/her foot from the brake pedal, the method proceeds to operation 712 and determines the minimum brake pressure necessary to hold braking of the vehicle based on the calculated grade.

When the EPB is utilized, there will be some lag time that occurs while the actuator (e.g., park brake motor) engages the park brake. During that lag time, brake pressure is held such that the driver does not realize vehicle motion while the EPB is engaged. Turning to operation 714, excessive pressure buildup in the pressure lines is released until the brake pressure equals or approximately reaches the minimum brake pressure at operation 716. When the minimum brake pressure is reached, the brake continues holding the brake pressure at operation 718 until the EPB is engaged. When the EPB is engaged at operation 720, the brake pressure is ramped out (i.e., precisely lowered) until the pressure reaches zero (i.e., 0 bar) at operation 722. At operation 724, a soft-park activation counter is incremented and the method ends at operation 726. As described above, the soft-park activation counter may be utilized to prevent excessive initiation of the soft-park operation. For instance, a driver may decide to no longer park the vehicle before the EPB is engaged, and instead may reapply the brake pedal causing the soft-park system to re-invoke the soft-park operation. If the soft-park activation counter reaches a threshold value during a pre-determined time period (e.g., 10 seconds), the soft-park system may prevent further usage of the soft-park operation until a reset period has been reached (e.g., 1 minute).

As used herein, the term “module” or “unit” refers to an application specific integrated circuit (ASIC), a field programmable gate array (FPGA), an electronic circuit, an electronic computer processor (shared, dedicated, or group) and memory that executes one or more software or firmware programs, a hardware microcontroller, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A soft-park control system configured to control vehicle movement during parking of a vehicle, comprising:
a transmission including a parking pawl that mechanically engages a notch in a parking gear;
at least one brake assembly, including an electro-mechanical actuator configured to apply a variable brake force to a wheel coupled to the at least one brake assembly based on an existing brake pressure; and
an electronic control unit including a soft-park hardware controller in electrical communication with the electro-mechanical actuator, the electronic brake control unit configured to output a brake pressure signal that adjusts the existing brake pressure so as to control a rate at which the parking pawl engages the notch.

2. The soft-park control system of claim 1, wherein the soft-park hardware controller is configured to calculate a calibration preference, and adjust the existing brake pressure based on the calculated calibration preference.

3. The soft-park control system of claim 2, wherein adjusting the existing brake pressure includes determining a pressure decay rate based on the calibration preference, and reducing the existing brake pressure at the decay rate until the existing brake pressure reaches a predetermined level.

4. The soft-park control system of claim 3, wherein the calculated calibration preference is a calculated surface grade of the vehicle, and wherein adjusting the existing brake pressure further comprises determining a minimum brake pressure based on the calculated surface grade, and releasing the existing brake pressure to approximately the minimum brake pressure prior to reducing the existing brake pressure at the decay rate.

5. The soft-park control system of claim 4, wherein the soft-park controller stores a plurality of minimum pressure values, each minimum pressure value corresponding to a pre-stored surface grade of the vehicle.

6. The soft-park control system of claim 5, wherein determining the minimum brake pressure includes matching the calculated surface grade of the vehicle to the pre-stored surface grades, selecting the minimum pressure value based on the match, and reducing the existing brake pressure until reaching approximately the minimum pressure value.

7. The soft-park control system of claim 1, wherein the soft-park controller includes a soft-park counter that is incremented in response to outputting the brake pressure signal, and wherein the parking pawl engages the notch without the soft-park controller controlling the existing brake pressure when a value of the soft-park counter exceeds a threshold value.

8. A soft-park control system configured to control parking of a vehicle, comprising:
at least one brake assembly including an electro-mechanical actuator configured to apply a variable brake force to a wheel coupled to the at least one brake assembly based on an existing brake pressure;
an electronic parking brake configured to apply a constant brake force that prevents rotation of a rotor included in the at least one brake assembly; and
an electronic control unit including a soft-park hardware controller in electrical communication with the electro-mechanical actuator, the electronic brake control unit configured to output a brake pressure signal that adjusts the existing brake pressure while engaging the electronic parking brake.

9. The soft-park control system of claim 8, wherein the soft-park hardware controller is configured to calculate a calibration preference, and adjust the existing brake pressure based on the calculated calibration preference.

10. The soft-park control system of claim 9, wherein adjusting the existing brake pressure includes determining when the engagement of the electronic parking brake is complete, and reducing the existing brake pressure to a predetermined level after completing engagement of the electronic parking brake.

11. The soft-park control system of claim 10, wherein the calculated calibration preference is a calculated surface grade of the vehicle, and wherein adjusting the existing brake pressure further comprises determining a minimum brake pressure based on the calculated surface grade of the vehicle, and reducing the existing brake pressure to approximately the minimum brake pressure prior to completing engagement of the electronic parking brake.

12. The soft-park control system of claim 11, wherein the soft-park controller stores a plurality of minimum pressure values, each minimum pressure value corresponding to a pre-stored surface grade.

13. The soft-park control system of claim 12, wherein determining the minimum brake pressure includes matching the calculated surface grade of the vehicle to the pre-stored surface grades, selecting the minimum pressure value based on the match, and reducing the existing brake pressure until reaching approximately the minimum pressure value.

14. The soft-park control system of claim 8, wherein the soft-park controller includes a soft-park counter that is incremented in response to outputting the brake pressure signal, and wherein the parking pawl engages the notch without the soft-park controller controlling the existing brake pressure when a value of the soft-park counter exceeds a threshold value.

15. A method of parking a vehicle, the method comprising:
detecting a request to transition the vehicle from a drive gear to a park gear;
mechanically transitioning a parking pawl from a disengaged state to an engaged state in response to the request; and
adjusting an existing brake pressure of the brake assembly so as to control a rate at which the parking pawl engages a notch on the park gear to park the vehicle.

16. The method of claim 15, further comprising determining a calibration preference, and adjusting the existing brake pressure based on the determined calibration preference

17. The method of claim 16, wherein adjusting the existing brake pressure further comprises determining a pressure decay rate based on the calibration preference, and reducing the existing brake pressure at the decay rate until reaching a predetermined level.

18. The method of claim 17, wherein adjusting the existing brake pressure further comprises:
calculating a surface grade of the vehicle;
determining a minimum brake pressure level based on the calculated surface grade of the vehicle;
prior to reducing the existing brake pressure at the decay rate, releasing the existing brake pressure to approximately the minimum brake pressure level; and
reducing the existing brake pressure from the minimum brake pressure level to approximately 0 pounds per square inch (psi) at the decay rate.

19. The method of claim 18, wherein determining the minimum brake pressure level comprises:
storing, in a recordable storage medium, a plurality of minimum pressure values, each minimum pressure value corresponding to a pre-stored surface grade;
matching the calculated surface grade of the vehicle to a pre-stored surface grade among the plurality of pre-stored surface grades;
selecting the minimum pressure value based on the match; and
reducing the existing brake pressure until reaching approximately the minimum pressure value.

20. The method of claim 15, further comprising incrementing a soft-park counter in response to outputting the brake pressure signal, and engaging the parking pawl in the notch without controlling the existing brake pressure when a value of the soft-park counter exceeds a threshold value.
